(19) United States
(12) Patent Application Publication
(10) Pub. No.: US 2011/0193771 A1
(43) Pub. Date: Aug. 11, 2011

(54) ELECTRONIC DEVICE CONTROLLABLE BY PHYSICAL DEFORMATION

(75) Inventor: Fredrik CHRONQVIST, Malmo (SE)

(73) Assignee: Sony Ericsson Mobile Communications AB, LUND (SE)

(21) Appl. No.: 12/703,462

(22) Filed: Feb. 10, 2010

(51) Int. Cl. G09G 5/00

(52) U.S. Cl. 345/156

(57) ABSTRACT

An electronic apparatus includes a display; at least two corners and, among them, at least two bendable corners; one or more sensors arranged to detect the state of bending of at least two corners, here referred to as actuating corners, among the at least two bendable corners; and a controller for controlling the position within the display of an element displayed on the display based on the state of bending of the actuating corners. A method and a computer program are also disclosed.

### TECHNICAL FIELD

The present invention relates to an electronic apparatus controllable by physical deformation, to a method for controlling such an electronic apparatus, and to a computer program including instructions configured to control the electronic apparatus.

### BACKGROUND

User interaction with an electronic device based on physical deformation of the device is known in the art.
C. Schwesig et al, “Gummi: a bendable computer”, CHI '04: Proceedings of the SIGCHI conference on Human factors in computing systems, pages 263-270, New York, N.Y., USA, 2004 (here referred to as reference [1]), relates to device with which users interacts by physically deforming it and by touching a sensor in its back.
G. Herkenrath et al, “TWEND: Twisting and Bending as new Interaction Gesture in Mobile Devices”, CHI 2008 Proceedings, Student Research Competition Apr. 5-10, 2008, Florence, Italy, pp. 3819-3824 (here referred to as reference [2]), distinguishes between eighteen bending gestures as input for a mobile device.

It is desirable to provide improved electronic devices and methods for controlling such devices with a particular emphasis on the convenience of use as well as on the user-device interaction efficiency.

### SUMMARY

Such devices, methods and computer programs are defined in the independent claims. Particular embodiments are defined in the dependent claims.

In one embodiment, an electronic apparatus includes a display; at least two corners and, among them, at least two bendable corners; one or more sensors arranged to detect the state of bending of at least two corners, here referred to as actuating corners, among the at least two bendable corners; and a controller for controlling the position within the display of an element displayed on the display based on the state of bending of the actuating corners.

Therefore, in this embodiment, the electronic apparatus is controllable by bending one, two or more of its corners. The corners which are used for controlling the electronic devices are called “actuating corners”. Sensors or sensing means are provided for detecting the state of bending of the actuating corners. Depending on whether a particular actuating corner is bent or not, the position of an element displayed within the display is controlled. In other words, the position of an element displayed within the display is changed, or not changed, depending notably on whether a particular actuating corner is bent or not.

By using the corners to control the position of an element within the display, an intuitive, convenient and efficient user interaction method is provided. Indeed, the display is usually not hidden by the hands or fingers used for deforming the corners. The hands and fingers can be simultaneously used for deforming the corners and for holding the electronic device. Furthermore, the two actuating corners can be placed relatively far apart from each other in comparison to points within the display, so that the user interaction method lends itself well to intuitive mechanical analogies wherein it may seem to the user as if the bending of the corner and the element's position and movement within the display were mechanically linked.

In one embodiment, the controller is configured, when one actuating corner is bent, to cause the element to move within the display towards or away from the bent actuating corner depending on the direction of bending.

In this embodiment, an intuitive relationship, or intuitive correlation, is provided between, on the one hand, the direction of bending, i.e. whether the corner is bent towards the user or away from the user, and, on the other hand, the movement of the element within the display. Namely, the element is either moved towards the bent actuating corner or away from the bent actuating corner in accordance with the direction of bending of the bent actuating corner. In this intuitive embodiment for the user, it is as if the bent actuating corner was mechanically attracting or was mechanically pushing away the element within the display depending on the direction of bending.

In one embodiment, the controller is configured, when one actuating corner is bent, to cause the element to move within the display at a certain pace or speed depending on the intensity of bending. In one embodiment, the controller is configured, when one actuating corner is bent, to cause the element to move within the display towards or away from the bent actuating corner at a certain pace or speed depending on both the direction of bending and the intensity of bending. These embodiments provide further intuitive user interaction methods.

In one embodiment, the controller is configured, when one actuating corner is bent towards a user looking at the display, to cause the element to move within the display away from the bent actuating corner; and, when one actuating corner is bent away from a user looking at the display, to cause the element to move within the display towards the bent actuating corner.

In this context, bending an actuating corner towards a user looking at the display means deforming the corner so that at least part of the corner is caused to move towards the eyes of a user looking at the display. In other words, bending an actuating corner towards a user looking at the display means slightly moving the corner within the space in front of the display, or more precisely within the space which is in front of the display when the actuating corner is not bent. Bending an actuating corner away from a user looking at the display means bending the corner away from the eyes of the user. In other words, bending the actuating corner away from a user looking at the display means bending the corner so that it slightly moves towards the space behind the device's side including the display.

In one embodiment, the controller is configured, when two actuating corners are bent, to cause the element to move within the display in a direction depending on the direction of bending of the two bent actuating corners.

In one embodiment, the controller is configured, when two actuating corners are bent, to cause the element to move within the display in a direction depending on the direction and intensity of bending of the two bent actuating corners.

In one embodiment, the element is a cursor. In another embodiment, the element is a selected area. In yet another embodiment, the element is a pointer. The cursor, the selected area, the pointer or the like may be similar to an element which would be controllable by a computer mouse if a computer mouse was used for controlling the position of such element within the display. The present method of interaction may be provided as an alternative way or an additional way to control an element's position within a display.

In one embodiment, a method is provided for controlling an electronic apparatus that includes a display, at least two corners and, among the at least two corners, at least two bendable corners. The method includes detecting the state of bending of at least two corners, here referred to as actuating corners, among the at least two bendable corners; and controlling the position within the display of an element displayed on the display based on the state of bending of the actuating corners.

In one embodiment, the method is such that controlling includes, when one actuating corner is bent, causing the element to move within the display towards or away from the bent actuating corner depending on the direction of bending.

In one embodiment, the method is such that controlling includes, when one actuating corner is bent towards a user looking at the display, causing the element to move within the display away from the bent actuating corner; and, when one actuating corner is bent away from a user looking at the display, causing the element to move within the display towards the bent actuating corner.

In one embodiment, the method is such that controlling includes, when two actuating corners are bent, causing the element to move within the display in a direction depending on the direction of bending of the two bent actuating corners.

In one embodiment, the method is such that controlling includes, when two actuating corners are bent, causing the element to move within the display in a direction depending on the direction and intensity of bending of the two bent actuating corners.

The invention also relates to a computer program including instructions configured, when executed on an electronic apparatus, to cause the electronic apparatus to carry out the above-described method.

### BRIEF DESCRIPTION OF THE DRAWINGS

Embodiments of the present invention shall now be described, in conjunction with the appended figures, in which:

FIGS. 1 to 9 schematically illustrate an electronic apparatus in a plurality of bending states, in one embodiment of the invention;

FIG. 10 schematically illustrates an electronic apparatus with some of its functional constituent elements in one embodiment of the invention; and

FIG. 11 is a flowchart of a method in one embodiment of the invention.

### DESCRIPTION OF SOME EMBODIMENTS

The present invention shall now be described in conjunction with specific embodiments. These specific embodiments serve to provide the skilled person with a better understanding, but are not intended to in any way restrict the scope of the invention, which is defined by the appended claims.

FIG. 1 schematically illustrates an electronic apparatus 10 having a rectangular shape defining four corners 16, 17, 18, 19. The corners may be rounded. The electronic apparatus 10 may be any one of a mobile phone, a game console, a smartphone, a laptop, a camera, or the like.

The electronic apparatus 10 includes a display 12 covering at least a portion of the front side of the apparatus 10. Among the four corners 16, 17, 18, 19, corners 18, 19 illustrated on the lower part of FIG. 1 are not bendable or, more precisely, not designed to be bendable and, especially, not designed to be bendable in order to control the apparatus 10. In contrast, corners 16, 17 illustrated on the upper part of FIG. 1, are bendable and, more precisely, designed to be bendable in order to control the apparatus 10.

In the apparatus 10 in the exemplary state illustrated in FIG. 1, none of the actuating corners 16, 17 are bent. A cursor 14 displayed within the display 12 is depicted as being stationary in the middle of the display 12, but could be anywhere else within the display 12.

In the exemplary state illustrated in FIG. 2, the upper right corner 17 is bent away from the user. Since corner 17 is an actuating corner, a sensor or corner bending detector is arranged to detect this particular bending state of corner 17. Accordingly, the position of the cursor 14 is changed in such a manner that the cursor 14 is displayed as moving towards the bent actuating corner 17, as illustrated by the dotted arrow in FIG. 2.

A finger, such as a thumb (not illustrated), may be used to bend the corner 17 in the manner illustrated in FIG. 2. Namely, a force may be applied to the corner 17 to bend it. The corner 17 material may be resilient so that, when the force is no longer applied on the corner 17, the corner is released and returns in the state illustrated in FIG. 1.

In one embodiment, controlling the position within the display of an element means controlling the x and y coordinates of the element within the display. This embodiment may be combined with any other embodiment described in the present document.

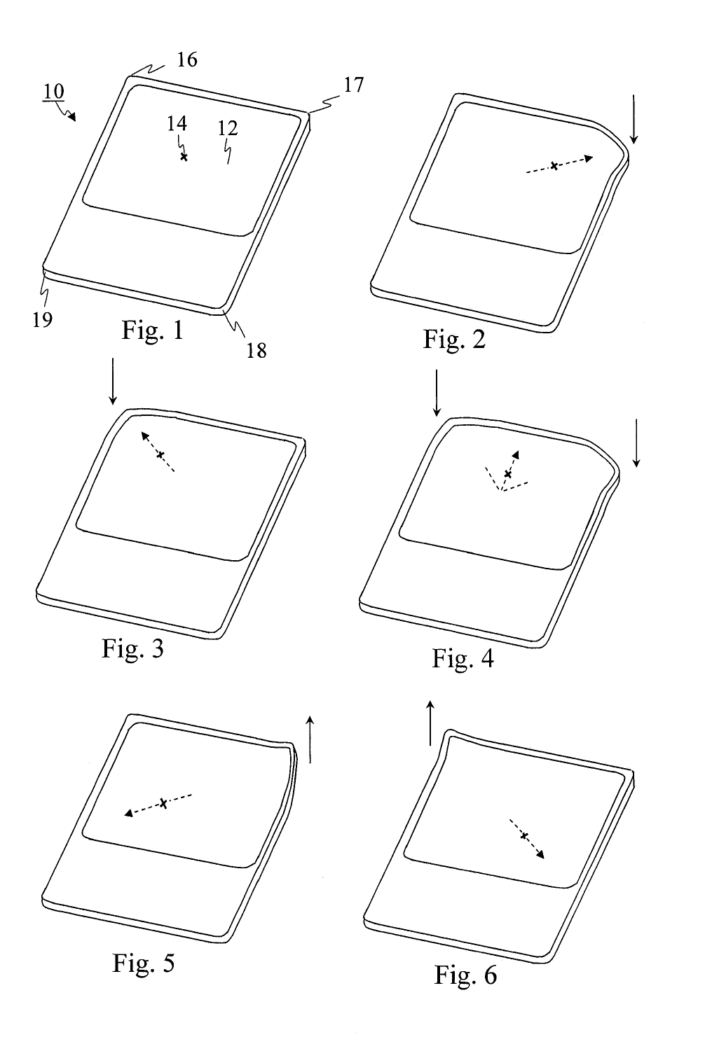

In the exemplary state illustrated in FIG. 3, the upper left actuating corner 16 is bent away from the user and the cursor 14 is accordingly caused to be displayed as moving towards the bent actuating corner 16.

In the exemplary state illustrated in FIG. 4, both actuating corners 16 and 17 are bent away from the user and, accordingly, the cursor 14 is caused to be displayed as moving towards the upper side of the display 12. The direction of movement of the cursor 14 within the display 12 may be viewed as corresponding to a vector resulting from the addition of two vectors, a first vector originating from the position of the cursor 14 and pointing in the direction of actuating corner 16 and a second vector originating from the position of the cursor 14 and pointing in the direction of actuating corner 17.

In the exemplary state illustrated in FIG. 5, the actuating corner 17 is bent towards a user. Accordingly, the cursor 14 is caused to be displayed as moving away the bent actuating corner 17.

In the exemplary state illustrated in FIG. 6, the actuating corner 16 is bent towards the user. Accordingly, the cursor 14 is caused to be displayed as moving away from the bent actuating corner 16.

In the exemplary state illustrated in FIG. 7, both actuating corners 16, 17 are bent towards the user. Accordingly, the cursor 14 is caused to be displayed as moving towards the lower side of the display 12.

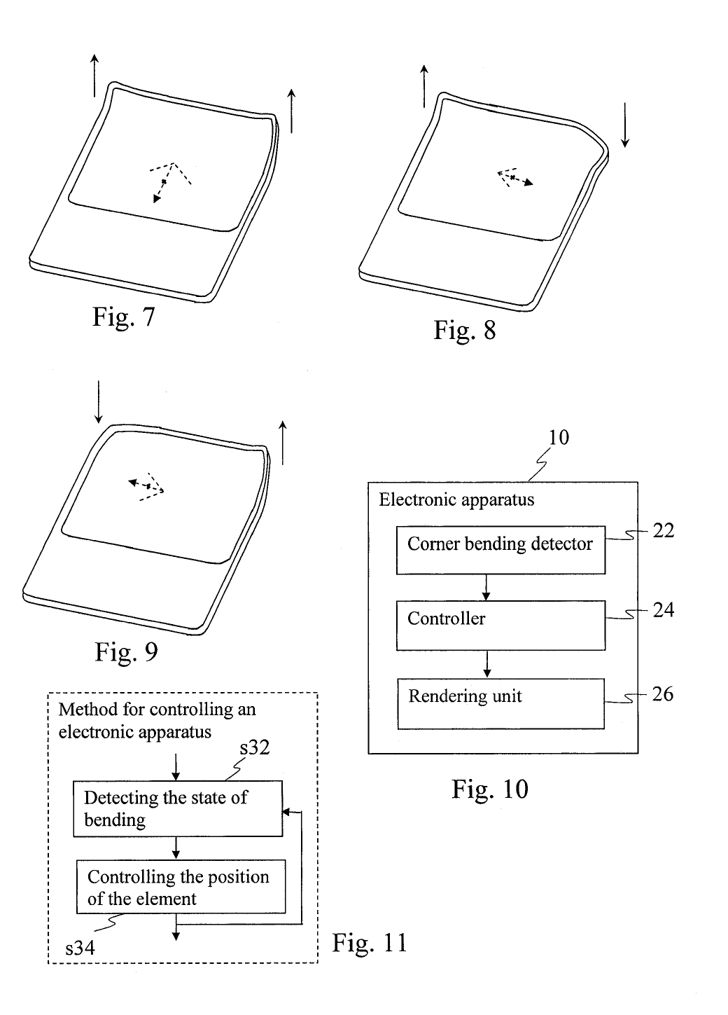

In the exemplary state illustrated in FIG. 8, the actuating corner 16 is bent towards the user and the actuating corner 17 is bent away from the user. Accordingly, the cursor 14 is caused to be displayed as moving within the display 12 towards the right side of the display 12.

Finally, in the exemplary state illustrated in FIG. 9, the actuating corner 16 is bent away from the user while the actuating corner 17 is bent towards the user. Accordingly, the cursor 14 is caused to be displayed as moving within the display 12 towards the left side of the display 12.

FIG. 10 schematically illustrates an electronic apparatus 10 and some of its constituent functional elements, in one embodiment of the invention. The electronic apparatus 10 includes a corner bending sensor 22, also called corner bending detector 22. The sensor 22 is arranged to detect the bending state of an actuating corner. One sensor 22 may be provided to detect the bending state of all actuating corners. Alternatively, one sensor 22 may be provided for each actuating corner. The sensor 22 may be embedded within the electronic apparatus 10.

Various bending sensors are known in the art. For instance, reference [1], page 265 and FIG. 4, discloses the use of resistive bend sensors. Reference [2] and U.S. Pat. No. 4,542,291 discloses the use of optical bend sensors. References [1] and [2] are mentioned in the above “Background” section.

The controller 24 may be a computer processing unit (CPU) on which a computer program may be executed. The computer program may include computer-understandable instructions for taking as input data representing the state of bending at particular time (including which actuating sensors are bent, in which directions, and with which corresponding intensities) and, based thereon, computing a new position (or position change) for the element 14 on the display 12. Data representing the computed resulting position is then transmitted to rendering unit 26 in charge of updating accordingly the position of the element 14 on the display 12.

So far, an electronic apparatus 10 defining four corners and, among these four corners, two actuating corners has been described. The invention is not limited to a particular number of corners, to a particular number of bendable corners or to a particular number of actuating corners. For instance, the device may include two corners which are both bendable and which both constitute actuating corners. In an example, the device front side has a semi-circular shape. In another example, the device includes six corners all being bendable but only four of them constituting actuating corners.

In one embodiment, the device 10 includes four corners which all constitute actuating corners. These four corners can be used for controlling the position of an element displayed on the device's display. Many kinds of movement of an element within the device's display may be triggered by combinations of bending states of the corners' device.

FIG. 11 is a flowchart of a method for controlling an apparatus in one embodiment of the invention. The method includes step s32 of detecting the state of bending of the actuating corners. Based on the detected state of bending, the position of an element within the display 12 is controlled in step s34. These steps may be repeated as illustrated in FIG. 11 by the arrow originating from the box associated with step s34 and leading to the box associated with step s32.

In one embodiment, bending one actuating corner is performed without bending a portion of each of the edges leading to the actuating corner. Two adjacent actuating corners are defined as being two actuating corners sharing a common edge. In one embodiment, bending two adjacent actuating corners is performed without bending an intermediary portion of the edge linking these two adjacent actuating corners.

In one embodiment, a portion of each of the edges leading to an actuating corner is not bendable or, more precisely, not designed to be bendable. In one embodiment, an intermediary portion of the edge linking two adjacent actuating corners is not bendable or, more precisely, not designed to be bendable. In one embodiment, an intermediary portion of each edge that links two adjacent actuating corners is not bendable or, more precisely, not designed to be bendable.

In one embodiment, a portion of an edge leading to an actuating corner is separately bendable from the actuating corner to enable to perform another control or user interaction. In one embodiment, an intermediary portion of the edge linking two adjacent actuating corners is separately bendable from the two adjacent actuating corners to enable to perform another control or user interaction.

The physical entities according to the invention, including the electronic apparatus may comprise or store computer programs including instructions such that, when the computer programs are executed on the physical entities, steps and procedures according to embodiments of the invention are carried out. The invention also relates to such computer programs for carrying out methods according to the invention, and to any computer-readable medium storing the computer programs for carrying out methods according to the invention.

Where the terms “corner bending detector”, “controller”, “rendering unit” are used herewith, no restriction is made regarding how distributed these elements may be and regarding how gathered they may be. That is, the constituent elements of the above corner bending detector, controller, rendering unit may be distributed in different software or hardware components or devices for bringing about the intended function. A plurality of distinct elements may also be gathered for providing the intended functionalities.

Any one of the above-referred elements of an apparatus may be implemented in hardware, software, field-programmable gate array (FPGA), application-specific integrated circuit (ASICs), firmware or the like.

In further embodiments of the invention, any one of the above-mentioned and/or claimed corner bending detector, controller, and rendering unit is replaced by detecting means, controlling means, and rendering means, respectively for performing the functions of the corner bending detector, controller, and rendering unit.

In further embodiments of the invention, any one of the above-described steps may be implemented using computer-readable instructions, for instance in the form of computer-understandable procedures, methods or the like, in any kind of computer languages, and/or in the form of embedded software on firmware, integrated circuits or the like.

Although the present invention has been described on the basis of detailed examples, the detailed examples only serve to provide the skilled person with a better understanding, and are not intended to limit the scope of the invention. The scope of the invention is much rather defined by the appended claims.

1. Electronic apparatus including
a display;
at least two corners and, among them, at least two bendable corners;
one or more sensors arranged to detect the state of bending of at least two corners, here referred to as actuating corners, among the at least two bendable corners; and
a controller for controlling the position within the display of an element displayed on the display based on the state of bending of the actuating corners.

2. Apparatus of claim 1, wherein the controller is configured, when one actuating corner is bent, to cause the element to move within the display towards or away from the bent actuating corner depending on the direction of bending.

3. Apparatus of claim 2, wherein the controller is configured,
when one actuating corner is bent towards a user looking at the display, to cause the element to move within the display away from the bent actuating corner; and,
when one actuating corner is bent away from a user looking at the display, to cause the element to move within the display towards the bent actuating corner.

4. Apparatus according to claim 1, wherein the controller is configured, when two actuating corners are bent, to cause the element to move within the display in a direction depending on the direction of bending of the two bent actuating corners.

5. Apparatus of claim 4, wherein the controller is configured, when two actuating corners are bent, to cause the element to move within the display in a direction depending on the direction and intensity of bending of the two bent actuating corners.

6. Apparatus according to claim 1, wherein the element is a cursor.

7. Apparatus according to claim 1, wherein the element is a selected area.

8. Method for controlling an electronic apparatus including
a display; and
at least two corners and, among them, at least two bendable corners; the method including
detecting the state of bending of at least two corners, here referred to as actuating corners, among the at least two bendable corners; and
controlling the position within the display of an element displayed on the display based on the state of bending of the actuating corners.

9. Method of claim 8, wherein controlling includes, when one actuating corner is bent, causing the element to move within the display towards or away from the bent actuating corner depending on the direction of bending.

10. Method of claim 9, wherein controlling includes,
when one actuating corner is bent towards a user looking at the display, causing the element to move within the display away from the bent actuating corner; and,
when one actuating corner is bent away from a user looking at the display, causing the element to move within the display towards the bent actuating corner.

11. Method according to claim 8, wherein controlling includes, when two actuating corners are bent, causing the element to move within the display in a direction depending on the direction of bending of the two bent actuating corners.

12. Method of claim 11, wherein controlling includes, when two actuating corners are bent, causing the element to move within the display in a direction depending on the direction and intensity of bending of the two bent actuating corners.

13. Method according to claim 8, wherein the element is a cursor.

14. Method according to claim 8, wherein the element is a selected area.

15. Computer program including instructions configured, when executed on an electronic apparatus, to cause the electronic apparatus to carry out the method according to claim 8.
